(19) United States
(12) Patent Application Publication
(10) Pub. No.: US 2006/0007323 A1
(43) Pub. Date: Jan. 12, 2006

(54) Imaging signal processing circuit and camera system

(75) Inventors: Yoshihisa Shimazu, Kyoto (JP); Masaaki Furutake, Kyoto (JP); Shinji Kitamura, Kyoto (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/176,369

(22) Filed: Jul. 8, 2005

(30) Foreign Application Priority Data
Jul. 9, 2004 (JP) P2004-203005
Jul. 1, 2005 (JP) P2005-193902

(51) Int. Cl. H04N 5/228

(52) U.S. Cl. 348/222.1

(57) ABSTRACT

An imaging signal processing circuit according to the present invention comprises a color signal processing unit for inputting a digital imaging signal obtained by vertically reading a signal from a solid imaging element by means of N-field interlace method and further digital-converting the signal and executing a color conversion processing for converting the digital imaging signal into a luminance signal and a color difference signal, a compression/expansion processing unit for executing a compression processing for estimating an encoding amount and thereby previously obtaining a compression rate using the color-converted digital imaging signal, the compression/expansion processing unit further compressing the digital imaging signals up to a field at which fetch of the digital imaging signal is completed before fetch of the digital imaging signal in a Nth field is completed based on the obtained compression rate and generating compressed image data, and an image data recording unit for transferring and recording the generated compressed image data with respect to a recording medium.

### BACKGROUND OF THE INVENTION

1. Field of the Invention

The present invention relates to an imaging signal processing circuit for processing a digital imaging signal obtained in a read operation with respect to a solid imaging element by means of the interlace method. The present invention further relates to a camera system.

2. Description of the Related Art

In recent years, a focus has been importantly placed on achieving a higher processing speed and increasing number of recorded contents in the technical field relating to a camera system.

In a camera system of a related technology shown in FIG. 9, an image of a photographic subject transmits through a photographic lens 41, is focused on a solid imaging element 42 such as CCD (Charge Coupled Device), photo-electrically converted based on a drive timing control executed by a solid imaging element drive unit 3, and outputted as an analog signal. Next, the analog signal is amplified and subjected to a noise removal and the like by an analog signal processing unit 44 and converted into a digital imaging signal by an analog/digital converting unit 45. The digital imaging signal is inputted to a color signal processing unit 51 of an imaging signal processing circuit 200 so that image signals, which are a luminance signal and a color difference signal, are generated by means of a color conversion processing, and the image signals are outputted to a compression/expansion processing unit 52. A compression processing for estimating an encoding amount and thereby obtaining a compression rate is executed to the image signals in the compression/expansion processing unit 52. Further, image data is compressed by means of, for example, the JPEG (Joint Photographic Coding Experts Group) method based on the obtained compression rate and outputted as compressed image data to be stored in an external memory 61. In a similar manner, thumbnail image data is generated and stored in the external memory 61 such as RAM (Random Access Memory). The compressed image data stored in the external memory 61 is processed into data in compliance with a standard format based on a control executed by a CPU 55 and inputted to an image data recording unit 53. The compressed image data is recorded on a recording medium 62 by the image data recording unit 53. The image signals outputted from the color signal processing unit 51 are displayed/outputted by a display output unit 54. FIG. 10 shows a data flow. FIG. 11 is an illustration of a three-field fetching method, and FIG. 12 is an illustration of a five-field fetching method.

The camera system of the related technology has the following problems: the external memory having a large capacity is required for temporarily memorizing the color-converted image data; the external memory is frequently accessed; a two-pass method, in which the encoding-amount-estimate compression processing is previously executed so as to obtain the compression rate in the compression/expansion processing unit and the image data is thereafter read from the external memory and compressed, has to be employed; and the image data outputted from the compression/expansion processing unit is written in the external memory, and the image data on the external memory is read based on the CPU control and recorded on the recording medium via the image data recording unit. Due to the foregoing problems, it is difficult to attain a high-speed processing.

### BRIEF SUMMARY OF THE INVENTION

1) A first imaging signal processing circuit according to the present invention comprises:

a color signal processing unit for inputting a digital imaging signal obtained by vertically reading a signal from a solid imaging element by means of N-field interlace method and further digital-converting the signal and executing a color conversion processing for converting the digital imaging signal into a luminance signal and a color difference signal;

a compression/expansion processing unit for executing a compression processing for estimating an encoding amount and thereby previously obtaining a compression rate using the color-converted digital imaging signal, the compression/expansion processing unit further compressing the digital imaging signals up to a field in N fields at which fetch of the digital imaging signal is completed before fetch of the digital imaging signal in a Nth field is completed based on the obtained compression rate and generating compressed image data;

an image data recording unit for transferring and recording the generated compressed image data with respect to a recording medium; and

a CPU (Central Processing Unit) for operating in accordance with a program stored in a program memory and controlling the color signal processing unit, the compression/expansion processing unit and the image data recording unit. In the foregoing constitution, “N” of the N fields is a natural number of at least two.

According to the foregoing constitution, because the compression rate is previously obtained in the encoding-amount-estimate compression processing, a sequence, in which the compression process is executed at same time as the execution of the color conversion processing and enlargement/reduction processing and the compressed image data is directly inputted to the recording medium without the intervention of the external memory, is realized. In other words, a one-pass method is realized, which leads to downsizing of the external memory as a work region in each processing and cost reduction. Further, number of accesses made to the external memory can be reduced, and a higher speed can be thereby realized.

The encoding-amount-estimate compression processing for obtaining the compression rate is preferably executed to the digital imaging signals comprised of entire vertical pixels or a part of the entire vertical pixels and entire horizontal pixels up to the fetch-completed field.

In the foregoing constitution, a horizontal pixel addition processing unit for horizontally adding/mixing the digital imaging signal fetched from the solid imaging element may be further provided in a previous stage of the color signal processing unit.

Accordingly, in the horizontal pixel addition processing unit, an aspect ratio of an estimated image in the horizontal and vertical directions can be adjusted to an aspect ratio of the picked-up image in the compression processing for estimating the encoding amount, an error possibly generated in the estimated encoding amount due to different frequency characteristics in the horizontal and vertical directions can be lessened.

Further, in the foregoing constitution, the CPU may determine an encoding amount adjustment parameter in accordance with image quality information inputted from outside.

In the foregoing constitution, the CPU determines a desired encoding amount in accordance with the image quality information using a predetermined algorithm and determines the encoding amount adjustment parameter based on a calculation implemented using the encoding amount in the encoding-amount-estimate compression processing executed before the fetch of the digital imaging signal in the Nth field is completed and the desired encoding amount.

According to the foregoing constitution, the image quality information such as the number of recorded pixels, image file size, or image quality mode (high image quality, ordinary image quality, low image quality or the like) is set by a user, and the compressed image data corresponding to the set image quality information can be thereby generated.

Further, in the foregoing constitution, the CPU may compare an encoding amount in compressing a body image using the determined encoding amount adjustment parameter to the desired encoding amount to thereby correct the predetermined algorithm in accordance with a magnitude correlation therebetween.

According to the foregoing constitution, the algorithm is corrected in each image shooting. Thereby, the encoding amount can be more accurately estimated as the number of the taken images is increased so as to obtain the desired encoding amount at the time of recording.

The present invention can be developed as a camera system as follows.

A camera system according to the present invention comprises:

a solid imaging element for converting a light received via a photographing lens into an electrical signal and outputting the electrical signal as an imaging signal;

an analog/digital converting circuit for digital-converting the imaging signal into a digital imaging signal; and

any of the before-mentioned imaging signal processing circuits.

Additional objects and advantages of the present invention will be apparent from the following detailed description of a preferred embodiment thereof, which are best understood with reference to the accompanying drawings.

### BRIEF DESCRIPTION OF THE DRAWINGS

FIG. 1 is a block diagram illustrating a constitution of a camera system in which an imaging signal processing circuit according to a preferred embodiment of the present invention is installed.

FIG. 2 is an illustration of a data flow according to the embodiment.

FIG. 3 is an illustration of a three-field fetching method according to an embodiment 1 of the present invention.

FIG. 4 is an illustration of output data from a solid imaging element in the three-field fetching method according to the embodiment 1.

FIG. 5 is an illustration of a five-field fetching method according to an embodiment 2 of the present invention.

FIG. 6 is an illustration of output data from a solid imaging element in the five-field fetching method according to the embodiment 2.

FIG. 7 is a flow chart of a learning sequence for improving an accuracy in estimating an encoding amount according to an embodiment 5 of the present invention.

FIG. 8 is a flow chart of a learning sequence for improving an accuracy in estimating an encoding amount in a three-field fetching method according to the embodiment 5.

FIG. 9 is a block diagram illustrating a constitution of a camera system of a related technology.

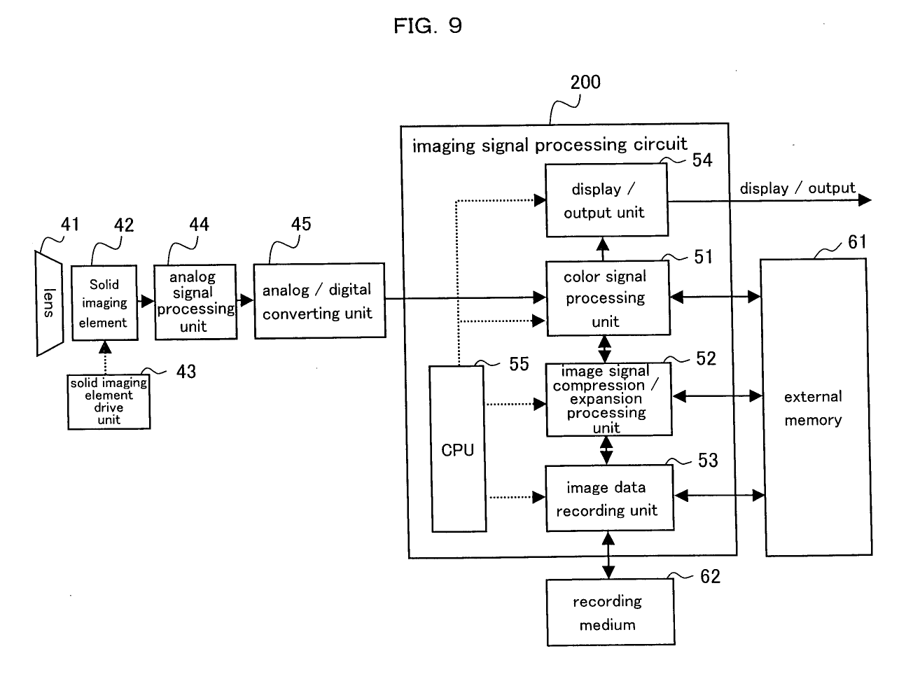

FIG. 10 is an illustration of a data flow in the camera system of the related technology.

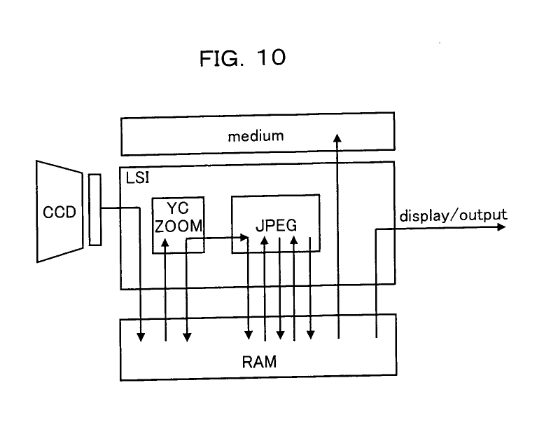

FIG. 11 is an illustration of a three-field fetching method of the related technology.

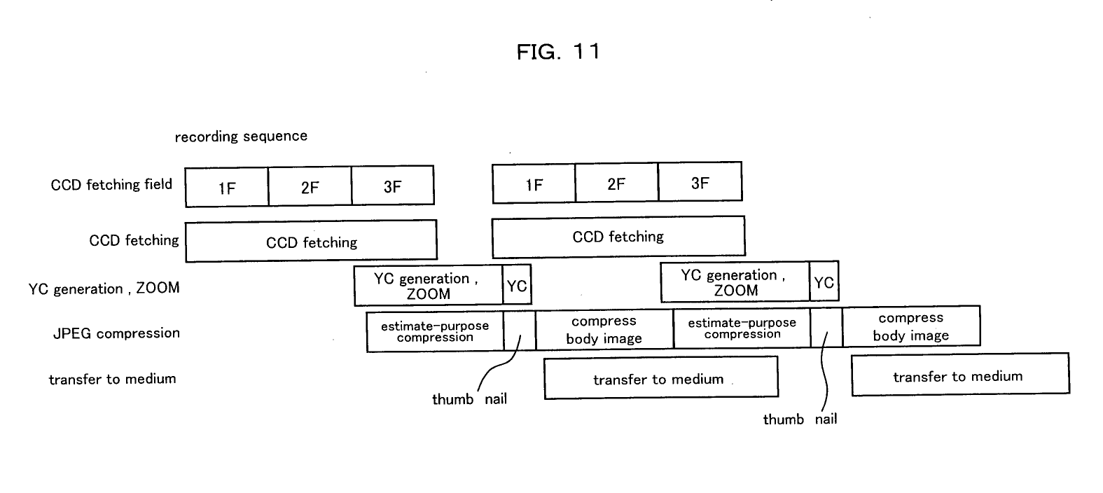

FIG. 12 is an illustration of a five-field fetching method of the related technology.

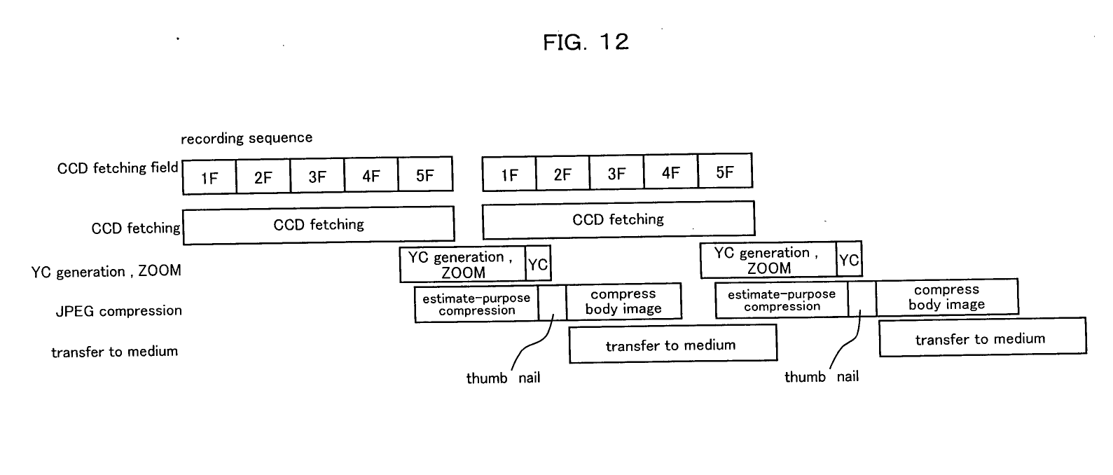

### DETAILED DESCRIPTION OF A PREFERRED EMBODIMENT

Hereinafter, a preferred embodiment of an imaging signal processing circuit according to the present invention is described in detail referring to the drawings.

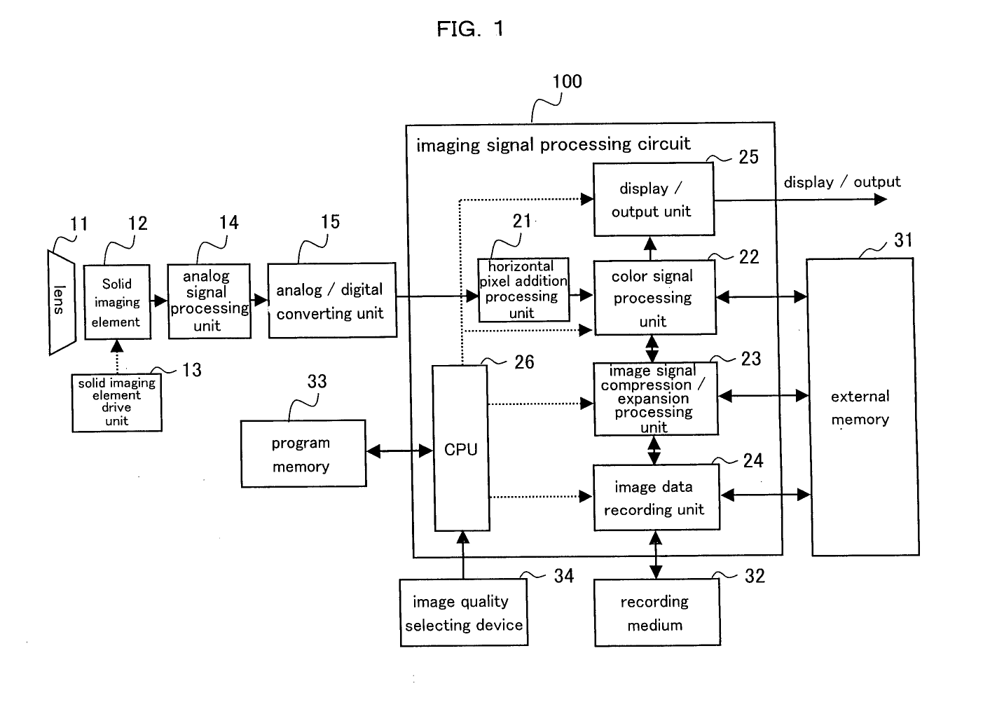

FIG. 1 is a block diagram illustrating a constitution of a camera system in which an imaging signal processing circuit according to the preferred embodiment is included. The camera system comprises a photographing lens 11, a solid imaging element 12, a slid imaging element drive unit 13, an analog signal processing unit 14, an analog/digital converting unit 15, an imaging signal processing circuit 100, an external memory 31, a recording medium 32, a program memory 33 and an image quality selecting device 34. CCD, for example, can be adopted as the solid imaging element 12. DRAM (Dynamic Random Access Memory), for example, can be adopted as the external memory 31.

The imaging signal processing circuit 100 is formed from LSI, and comprises a horizontal pixel addition processing unit 21, a color signal processing unit 22, an image data compression/expansion processing unit 23, an image data recording unit 24, a display/output unit 25 and a CPU 26.

The color signal processing unit 22 converts a digital imaging signal into a luminance signal and a color difference signal, and executes a color conversion processing for enlarging/reducing the signals to an optional size. The compression/expansion processing unit 23 executes a compression processing for estimating an encoding amount and thereby previously obtaining a compression rate employed in compressing image data using the color-converted digital imaging signal, and executes a body image compression processing using the obtained compression rate. The data processing unit 24 executes a medium transfer processing for transferring the compressed image data to the medium. The display/output unit 25 executes a display/output processing for outputting the image data to an external device. The color signal processing unit 22, compression/expansion processing unit 23, image data recording unit 24 and display/output unit 25 are controlled by the CPU 26. The horizontal pixel addition processing unit 21 is a circuit for vertically thinning pixels by 1/N (N≧2) and horizontally adding/mixing entire horizontal pixels to N pixels. The horizontal pixel addition processing unit 21 is not an indispensable component to be provided.

The program memory 33 stores therein a program for operating the camera system. The CPU 26 reads the program from the program memory 33 and executes it. It is possible for the CPU 26 to rewrite contents of the program memory 33.

The image quality selecting device 34 is a mechanism to be selected by a user using a switch or a menu, wherein the user selects number of pixels to be recorded, image file size, or image quality mode (high image quality, ordinary image quality, low image quality or the like), and the selected image quality information is transmitted to the CPU 26.

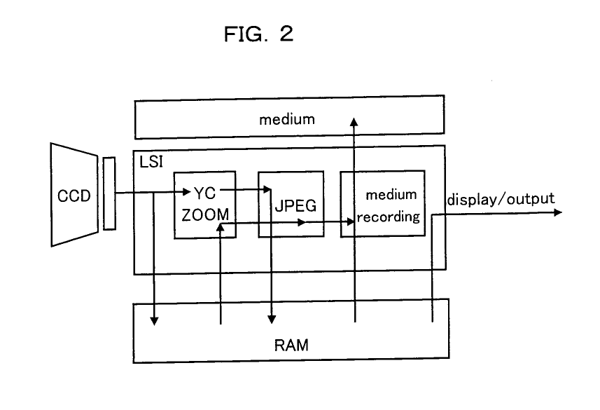

Next, an operation of the camera system according to the present embodiment having the foregoing constitution is described. FIG. 2 shows a data processing flow in the camera system according to the present embodiment.

An image of a photographic subject transmits through the photographic lens 11, is focused on the solid imaging element 12, and photo-electrically converted based on a drive timing of the solid imaging element drive unit 13 to be thereby outputted as an analog signal. Next, the analog signal is amplified and subjected to a noise removal and the like by the analog signal processing unit 14 and converted into a digital imaging signal by the analog/digital converting unit 15.

The imaging signal processing circuit 100, to which the image signal converted into the digital imaging signal by the analog/digital converting unit 15 is inputted, uses the external memory 31 as a work region, and converts the inputted digital imaging signal into image data (encoded data). Below is described in detail an operation of the imaging signal processing circuit 100.

The digital imaging signal transmits through the horizontal pixel addition processing unit 21 and is inputted to the color signal processing unit 22. Then, the digital imaging signal is subjected to the color conversion processing by the color signal processing unit 22 so that the image signals, which are the luminance signal and the color difference signal, are generated. The generated image signals are enlarged or reduced if necessary. The color conversion processing is necessary for displaying the image data on the external device such as a monitor and compressing the image data as recording data. The color-converted digital imaging signal is transmitted to the display/output unit 25 and the compression/expansion processing unit 23. The image signal is compressed by means of the JPEG by the compression/expansion processing unit 23 and outputted as the compressed image data. If necessary, the compressed image data is expanded. The compressed image data is recorded on the recording medium 32 by the image data recording unit 24. The image data outputted from the color signal processing unit 22 is displayed/outputted by the display output unit 25.

### Embodiment 1

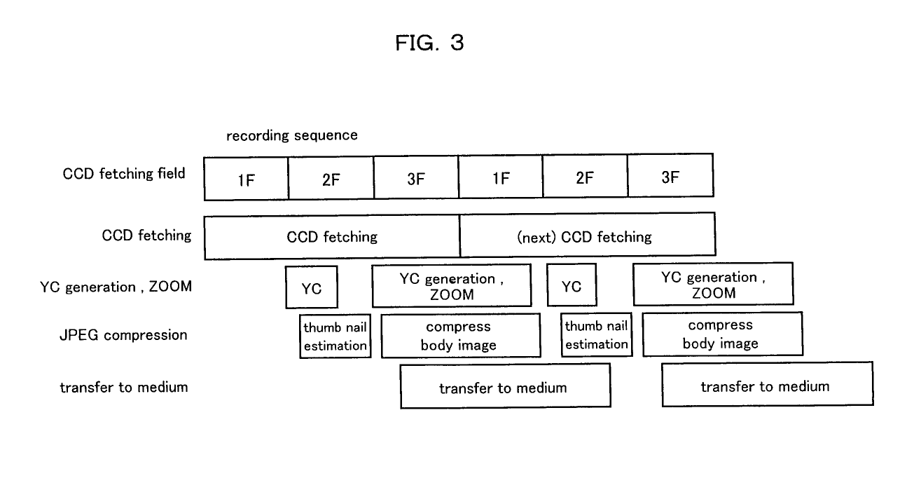

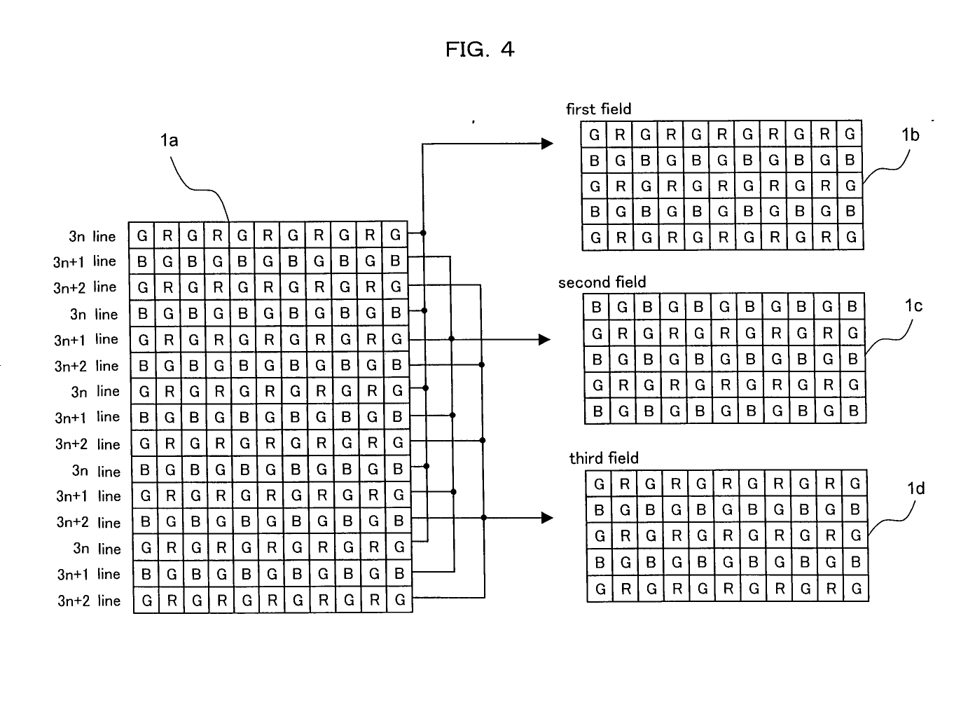

FIG. 3 shows a processing sequence of the camera system when the three-field fetching method is employed as an embodiment 1 of the present invention. First, a data fetching processing in the three-field fetching method is described referring to FIG. 4.

In the three-field fetching method, the imaging signal from the solid imaging elements is outputted per 3n lines. An imaging signal 1a is fetched in the order of a first field 1b, a second field 1c and a third field 1d. First, the digital imaging signal of the first field is fetched into the external memory 31.

In the case of providing the horizontal pixel addition processing unit 21, horizontally added/mixed field data and/or non-added/non-mixed field data are fetched.

Next, in parallel with fetch of the second field data into the external memory 31, the first field data is read from the external memory 31 and subjected to the color conversion processing by the color signal processing unit 22. To be brief, the image signals, which are the luminance signal and the color difference signal, are generated.

Next, the generated luminance signal and color difference signal are inputted to the compression/expansion processing unit 23 to be compressed therein so that the compression processing for estimating the encoding amount and thereby obtaining the compression rate is executed. The compression processing for estimating the encoding amount and thereby obtaining the compression rate refers to an image data compressing processing previously executed in order to obtain the compression rate used in compressing the image data. The compression processing for estimating the encoding amount and thereby obtaining the compression rate is necessary for compressing the image data to a certain size or an optional size, wherein a processing for obtaining the compression rate required for compressing the image data is executed using the processing result.

Further, a thumb nail color conversion processing is executed using the first field data read from the external memory 31, and the imaging signal is converted into the luminance signal and the color difference signal and converted into a size of vertical 16 pixels and horizontal 120 pixels, which is a thumb nail size. The thumb nail color conversion processing is necessary for the data recording conforming to standards such as DCF (Design Rule for Camera File System) and DPOF (Digital Print Order Format), and the processing result is used to compress the thumb nail image data and display/output the thumb nail image.

Based on the generation of the thumb nail image data, the pixels are digitally thinned in the horizontal direction, an angle of view is adjusted by means of the addition/mixing processing and the like, and the thumb nail-use luminance signal and color difference signal are generated. In the case of providing the horizontal pixel addition processing unit 21, it becomes unnecessary to digitally adjust the angel of view because the pixels are already added/mixed in the horizontal direction and the angel of view is already adjusted.

Next, the thumb nail-use luminance signal and color difference signal are inputted to the compression/expansion processing unit 23 to be compressed therein, and the thumb nail image is data-compressed. The thumb nail image data compression is necessary for the data recording conforming to the standards such as the DCF and DPOF. The processing result is used to execute the transfer process with respect to the recording medium. The generated thumb nail image data is transferred to the recording medium 32.

Next, in parallel with fetch of the third field data, the first field data and/or the second field data corresponding to the vertical direction are read from the external memory 31. Thereby, the continuous digital imaging signals are serially accomplished. Each of the accomplished serial digital imaging signals is subjected to a body color signal processing executed by the color signal processing unit 22. To be brief, the image signals, which are the luminance signal and the color difference signal, are generated.

Next, a part or all of the foregoing continuous imaging signals are inputted to the compression/expansion processing unit 23 to be compressed therein so that the body image is compressed. The compressed image data of the compressed body image is recorded on the recording medium 32 via the image data recording unit 24 based on the CPU control.

In the present embodiment, the compression rate is already determined in the compression processing for estimating the encoding amount and thereby obtaining the compression rate, which is previously executed. Therefore, it becomes unnecessary to return the color-converted digital imaging signal to the external memory 31 in order to execute the encoding-amount-estimate compressing processing as in the related technology so that the body image can be compressed. Thereby, the number of the bus accesses with respect to the external memory 31 can be lessened, and power consumption can be favorably reduced. Further, a processing speed can be improved because the compression processing for estimating the encoding amount and thereby obtaining the compression rate is already completed. Further, it is possible to rewrite a code header data on the recording medium 32 by the CPU 26.

In the present embodiment, the thumb nail image data can be previously generated because the thumb nail color conversion processing and the thumb nail image data compression processing are previously executed. As a result, for example, when the image data conforming to the standards such as the DCF and DPOF is generated, the compressed body data can be directly transferred to the recording medium 32 without returning to the external memory 31 because the thumb nail image data is already generated at that time. Thereby, the number of the accesses with respect to the external memory bus can be lessened, and the processing speed can be increased.

The sequence in which the compression processing for estimating the encoding amount and thereby obtaining the compression rate, the thumb nail image data compression processing and the like was described using the first field data fetched into the external memory 31. However, as shown in FIG. 2, a direct path from the CCD to YC/ZOOM is provided in the present embodiment. Therefore, the compression processing for estimating the encoding amount and thereby obtaining the compression rate and the thumb nail image data compression processing can be executed using the first field data in parallel with the fetch of the first-field data. In the foregoing case, the encoding-amount-estimate compression processing can be further executed using the data up to the second field in parallel with the fetch of second field data. In the foregoing manner, though the increase of the power consumption cannot be avoided because the encoding-amount-estimate compression processing is executed a plurality of times, the compression rate can be accurately calculated as a result of executing the encoding-amount-estimate compression the plurality of times. Thereby, the body image compression at a more appropriate compression rate can be realized.

In the case of providing the horizontal pixel addition processing unit, it is not necessary to use the mixed pixels in order to execute the thumb nail color conversion processing, thumb nail image data compression processing, body color conversion processing and compression processing for estimating the encoding amount and thereby obtaining the compression rate. The mixed pixels and non-mixed pixels may be appropriately selected.

According to the present embodiment, the thumb nail color conversion processing and the thumb nail image data compression processing are previously executed so that the image data can be written in the recording medium without returning to the external memory. Thereby, the number of the accesses with respect to the external memory can be reduced. Further, the external memory as the work region in each processing can be downsized, favorably resulting in a cost reduction.

Because the compression rate is previously obtained in the encoding-amount-estimate compression processing, the sequence, in which the compression processing is executed at the same time as the color conversion processing and the enlargement/reduction processing, and the image data is directly inputted to the recoding medium without the intervention of the external memory, can be realized. More specifically, the one-pass method can be realized, the external memory as the work region in each processing can be downsized, and the cost reduction can be realized. Further, the number of the accesses with respect to the external memory can be reduced thereby attaining a higher speed.

Further, in the horizontal pixel addition processing unit, an aspect ratio of the estimated image in the horizontal and vertical directions can be adjusted to an aspect ratio of the picked-up image in the encoding-amount-estimate compression processing. Thereby, an error possibly generated in the estimated encoding amount due to different frequency characteristics in the horizontal and vertical directions can be lessened.

### Embodiment 2

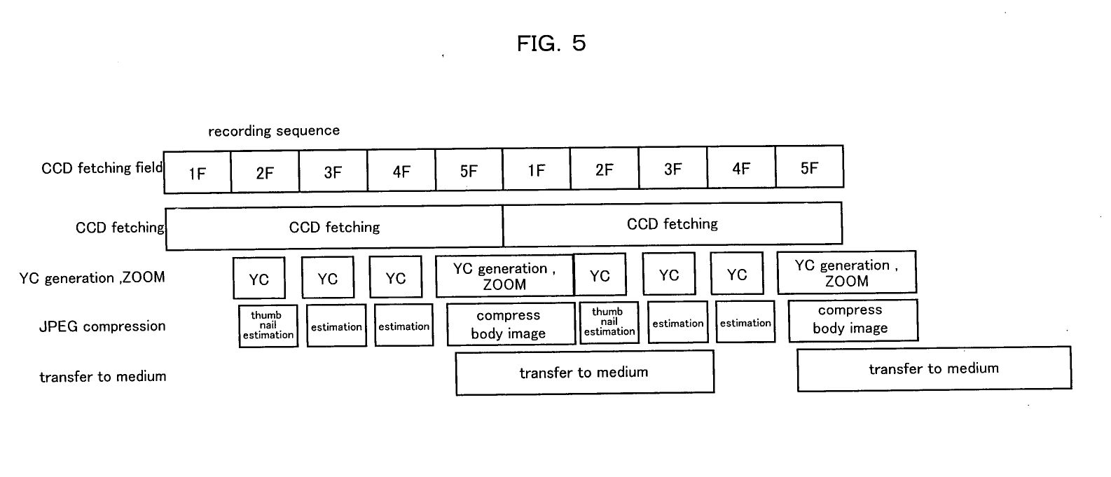

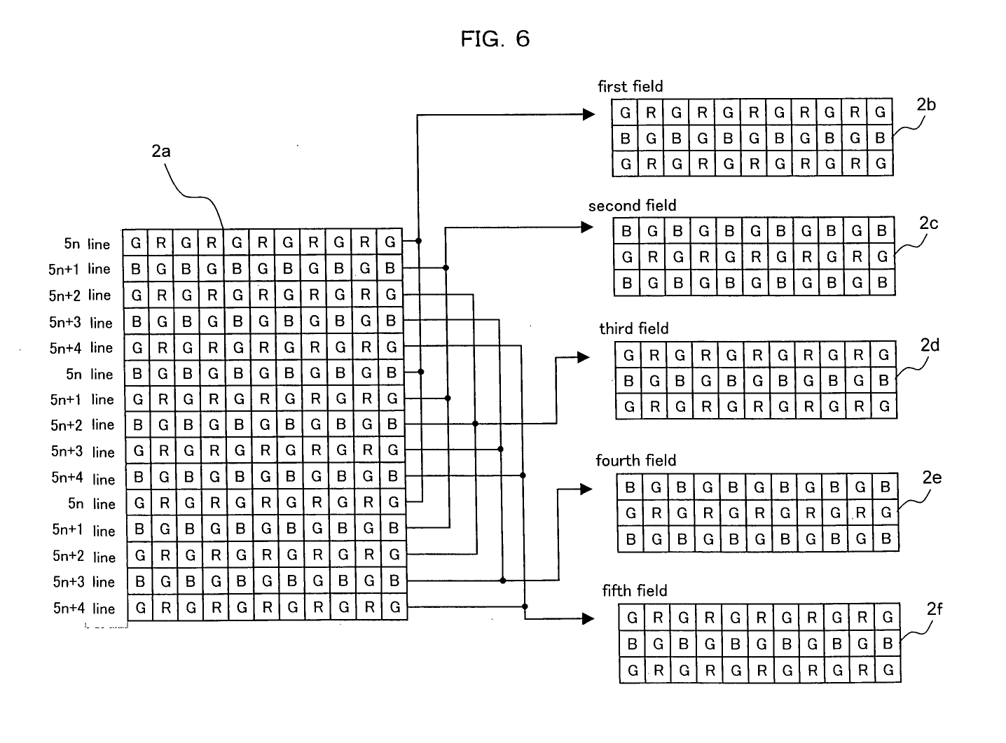

As an embodiment 2 of the present invention, FIG. 5 shows a processing sequence of the camera system when the five-field fetching method is employed. First, a data fetching processing in the five-field fetching method is described referring to FIG. 6. In the five-field fetching method, the imaging signal from the solid imaging element is outputted per 5n lines. An imaging signal 2a is fetched in the order of a first field 2b, a second field 2c, a third field 2d, a fourth field 2e and a fifth field 2f. First, the first field data is fetched into the external memory 31.

In the similar manner as in the embodiment 1, the first field data and the second field data are processed, and thereafter, the first field data and/or the second field data corresponding to the vertical direction is read from the external memory 31 in parallel with fetch of the third field data. Then, the read data is subjected to the color conversion processing, compression processing for estimating the encoding amount and thereby obtaining the compression rate, thumb nail color conversion processing, and thumb nail image data compression processing.

In the similar manner, the first field data and/or second field data or/and third field data corresponding to the vertical direction are read from the external memory 31 in parallel with fetch of the fourth field data and subjected to the color conversion processing, compression processing for estimating the encoding amount and thereby obtaining the compression rate, thumb nail color conversion processing, and thumb nail image data compression processing. Thereby, the continuous digital imaging signals are serially accomplished, and the body color conversion processing is executed by the color signal processing unit 22 to each of the accomplished continuous digital imaging signals. The rest of the constitution corresponds to the description of the embodiment 1.

### Embodiment 3

As an embodiment 3 of the present invention, for example, in the processing sequence in the three-field fetching method shown in FIG. 3, a preliminary processing such as an OB (Optical Black) clamp processing may be executed using the first-field imaging data when the second field is fetched. The OB cramp processing is a processing for correcting a black level, that is a reference level, to a constant value using a light-shielded region. The correction does not require the data of all of the fields, however, spatially uses the data of the entire region. Therefore, the correction can be appropriately carried out, and the processing speed can be remarkably increased in comparison to the related technology.

### Embodiment 4

As an embodiment 4 of the present invention, for example, in the processing sequence in the three-field fetching method shown in FIG. 4, a photometric processing such as a WB (White Balance) processing may be executed using the first field data when the second field is fetched. The WB processing is a white balance gain adjustment processing, wherein a proportion of the color difference signal is adjusted based on the imaging data. The adjustment does not require the data of all of the fields, however, spatially uses the data of the entire region. Therefore, the adjustment can be appropriately carried out, and the processing speed can be remarkably increased in comparison to the related technology.

### Embodiment 5

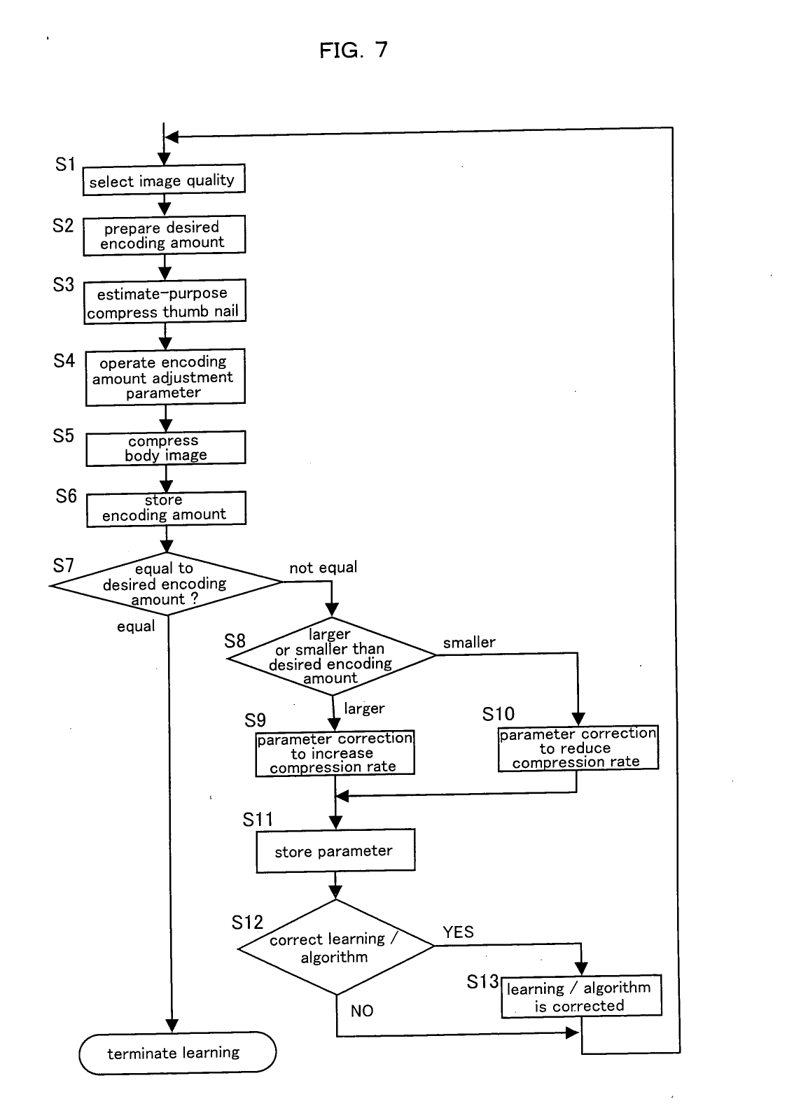

As an embodiment 5 of the present invention, a learning sequence for improving an accuracy in estimating the encoding amount of the body image with each photographing is described referring to a flow chart of FIG. 7.

The CPU 26 operates in accordance with a program (predetermined algorithm) for setting an encoding amount adjustment parameter stored in the program memory 33.

In Step S1, an image quality is selected by means of the image quality selecting device 34 shown in FIG. 1. The image quality refers to number of pixels to be recorded, image file size or image quality mode (high image quality, ordinary image quality, low image quality and the like), which is selected by the user. In Step S2, the CPU 26 prepares an estimated desired encoding amount regarding the number of pixels to be recorded and compression rate of the thumb nail image. The same numbers of recorded pixels may require the different compression rates. In Step S3, the CPU 26 executes the encoding-amount-estimate compression processing to the thumb nail image. In Step S4, the encoding amount adjustment parameter is operated in accordance with the predetermined algorithm. In the operation process, an estimated encoding amount of the body image is obtained based on the actual encoding amount of the thumb nail image obtained in the encoding-amount-estimate compression processing and a ratio of the number of pixels of the thumb nail image relative to the number of pixels of the body image. Then, the encoding amount adjustment parameter actually used in the thumb nail image is converted based on a difference between the estimated encoding amount of the body image and the desired encoding amount so that the encoding amount adjustment parameter is determined. In Step S5, the body image is compressed based on the encoding amount adjustment parameter determined in the Step S4. In Step S6, the compressed body image is recorded, and the encoding amount of the body image is stored.

In Step S7, the encoding amount in compressing the body image and the desired encoding amount are compared to each other, and the sequence is terminated when the encoding amount of the body image and the desired encoding amount are equal because the estimation is completely accurate in that case. When they are different, the encoding amount in compressing the body image and the desired encoding amount are compared to each other in S8. When the encoding amount in compressing the body image is larger than the other, the parameter is corrected so as to increase the compression rate in Step S9, while the parameter is corrected so as to reduce the compression rate in Step S10 when the encoding amount in compressing the body image is smaller. When the parameter is thus corrected, the encoding amount in compressing the body image can be approximate to the desired encoding amount.

In Step S11, the CPU 26 stores the parameter correction amount obtained in the Step S9 or S10 therein. The CPU 26 analyzes characteristics of each image such as color distribution and composition (for example, person/landscape) for each photographing and stores the analysis result as additional information therein. In Step S12, the CPU 26 judges whether or not the learning and the algorithm for setting the encoding amount adjustment parameter are corrected based on a plurality of parameter correction results and characteristics of picked-up images, which are stored with each photographing. When the recorded contents are few, population of the stored data is small. In order to prevent the divergence of the algorithm due to the learning based on a small number, the Step S12 is provided so that the learning is based on a desired number of photographed contents. When it is decided that the learning and the algorithm are corrected, the algorithm or operational expression are corrected through a feedback in a direction where the correction amount converges to a small value in Step S13.

Omitting the Steps S11 through S13, the parameter is corrected in each photographing, which is also effective.

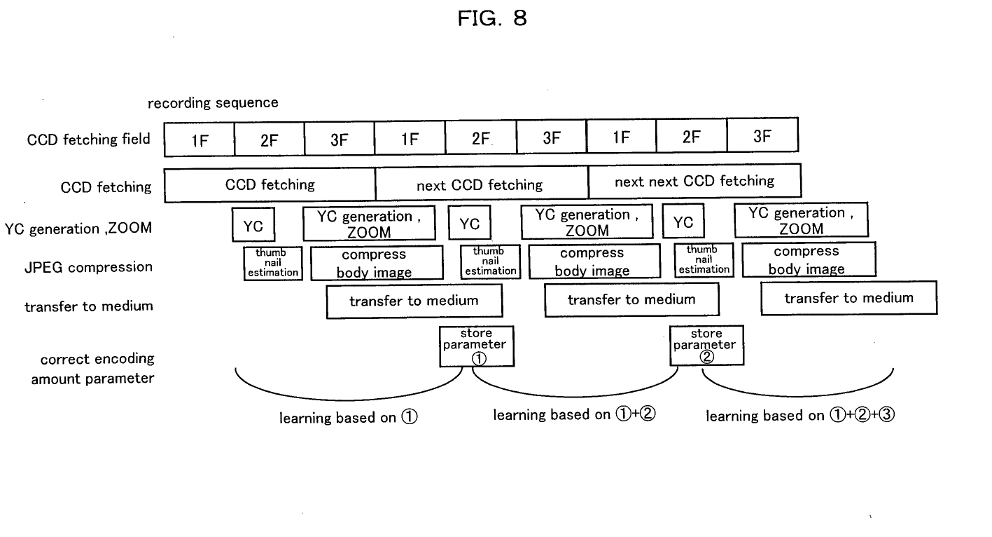

FIG. 8 shows a sequence in the case of adopting the present embodiment in the processing sequence in the three-field fetching method. Provided that the photographing is repeated n times (n is a natural number equal to or more than two), number of samples of the stored data used for the learning is n−1. As the photographing frequency n is increased, the number of the samples is also increased, which generates an expectation for improving the accuracy.

The parameter and the parameter correction amount stored in the Step S11 and the corrected algorithm and operational expression in the Step S12 are written in the program memory 33 by the CPU 26 when a power supply or a system is activated or the relevant program is not used, and then, read from the program memory 33 and used when the program is executed next.

According to the present embodiment, the accuracy in estimating the encoding amount is improved as the photographed contents are increased when the parameter is corrected and the algorithm is modified with each photographing, and the desired encoding amount can be thereby obtained in the recording operation with respect to the recording medium.

The respective components constituting the respective embodiments may be realized by means of software in a microcomputer.

The present invention is not limited to the described embodiment, and can be variously modified and implemented within the true spirit and scope of the invention.

As thus far described, the imaging signal processing circuit according to the present invention is effective as an imaging signal processing circuit or the like installed in a camera system in which an external memory has a small capacity, the external memory is less frequently accessed, and a high-speed operation is achieved.

What is claimed is:

1. An imaging signal processing circuit comprising:
a color signal processing unit for inputting a digital imaging signal obtained by vertically reading a signal from a solid imaging element by means of N-field interlace method and further digital-converting the signal and executing a color conversion processing for converting the digital imaging signal into a luminance signal and a color difference signal;
a compression/expansion processing unit for executing a compression processing for estimating an encoding amount and thereby previously obtaining a compression rate using the color-converted digital imaging signal, the compression/expansion processing unit further compressing the digital imaging signals up to a field in N fields at which fetch of the digital imaging signal is completed before fetch of the digital imaging signal in a Nth field is completed based on the obtained compression rate and generating compressed image data;
an image data recording unit for transferring and recording the generated compressed image data with respect to a recording medium; and
a CPU for operating in accordance with a program stored in a program memory and controlling the color signal processing unit, the compression/expansion processing unit and the image data recording unit.

2. An imaging signal processing circuit as claimed in claim 1, wherein the compression/expansion processing unit executes the compression processing for estimating the encoding amount and thereby obtaining the compression rate to the digital imaging signals comprised of entire vertical pixels or a part of the entire vertical pixels and entire horizontal pixels up to the fetch-completed field.

3. An imaging signal processing circuit as claimed in claim 1, wherein a horizontal pixel addition processing unit for horizontally adding/mixing the digital imaging signal fetched from the solid imaging element is provided in a previous stage of the color signal processing unit.

4. An imaging signal processing circuit as claimed in claim 1, wherein the compression/expansion processing unit executes the compression processing for estimating the encoding amount and thereby obtaining the compression rate to the digital imaging signals comprised of entire vertical pixels or a part of the entire vertical pixels and horizontally added/mixed pixels by the horizontal pixel addition processing unit up to the fetch-completed field.

5. An imaging signal processing circuit as claimed in claim 1, wherein a display/output unit for outputting an image signal in the color signal processing unit to an external device is provided.

6. An imaging signal processing circuit as claimed in claim 1, wherein the compression/expansion processing unit executes the data compression using the digital imaging signals of entire pixels in N fields based on the compression rate obtained in the compression processing for estimating the encoding amount in parallel with fetch of the digital imaging signal in the Nth field to thereby generated compressed image data.

7. An imaging signal processing circuit as claimed in claim 1, wherein the compression/expansion processing unit executes a compression processing for generating thumb nail image data using the digital imaging signals up to the fetch-completed field up to a (N−1)th field before the fetch of the digital imaging signal in the Nth field is completed.

8. An imaging signal processing circuit as claimed in claim 7, wherein the image data recording unit transfers the generated thumb nail image data to the recording medium without intervention of the external memory.

9. An imaging signal processing circuit as claimed in claim 1, wherein the color signal processing unit executes a preliminary processing such as an OB clamp processing using the digital imaging signals up to the fetch-completed field.

10. An imaging signal processing circuit as claimed in claim 1, wherein the color signal processing unit executes a photometric processing such as a white balance processing using the digital imaging signals up to the fetch-completed field.

11. An imaging signal processing circuit as claimed in claim 1, wherein the CPU determines an encoding amount adjustment parameter in accordance with image quality information inputted from outside.

12. An imaging signal processing circuit as claimed in claim 11, wherein the image quality information includes at least number of pixels to be recorded or an image quality mode.

13. An imaging signal processing circuit as claimed in claim 11, wherein the CPU determines a desired encoding amount in accordance with the image quality information using a predetermined algorithm, and determines the encoding amount adjustment parameter based on a calculation implemented based on an encoding amount in the compression processing for estimating the encoding amount executed prior to the fetch of the digital imaging signal of the Nth field is completed and the desired encoding amount.

14. An imaging signal processing circuit as claimed in claim 13, wherein the CPU compares an encoding amount in compressing a body image using the determined encoding amount adjustment parameter and the desired encoding amount to each other, and modifies the predetermined algorithm in accordance with a magnitude correlation therebetween.

15. An imaging signal processing circuit as claimed in claim 13, wherein the CPU stores information indicating a relationship between a difference between an encoding amount in compressing the body image and the desired encoding amount and the encoding amount adjustment parameter in the program memory in a plurality of photographings, and modifies the predetermined algorithm based on the information indicating the relationship.

16. An imaging signal processing circuit as claimed in claim 15, wherein the CPU further stores information indicating characteristics of a picked-up image in the program memory in the plurality of photographings, and modifies the predetermined algorithm additionally referring to the characteristics of the picked-up image.

17. A camera system comprising:
a solid imaging element for converting a light received via a photographing lens into an electrical signal and outputting the electrical signal as an imaging signal;
an analog/digital converting circuit for digital-converting the imaging signal into a digital imaging signal; and
the imaging signal processing circuit recited in claim 1.

18. A camera system comprising:
a solid imaging element for converting a light received via a photographing lens into an electrical signal and outputting the electrical signal as an imaging signal;
an analog/digital converting circuit for digital-converting the imaging signal into a digital imaging signal; and
the imaging signal processing circuit recited in claim 3.

19. A camera system comprising:
a solid imaging element for converting a light received via a photographing lens into an electrical signal and outputting the electrical signal as an imaging signal;
an analog/digital converting circuit for digital-converting the imaging signal into a digital imaging signal; and
the imaging signal processing circuit recited in claim 5.

20. A camera system comprising:
a solid imaging element for converting a light received via a photographing lens into an electrical signal and outputting the electrical signal as an imaging signal;
an analog/digital converting circuit for digital-converting the imaging signal into a digital imaging signal; and
the imaging signal processing circuit recited in claim 13.

21. A camera system comprising:
a solid imaging element for converting a light received via a photographing lens into an electrical signal and outputting the electrical signal as an imaging signal;
an analog/digital converting circuit for digital-converting the imaging signal into a digital imaging signal; and
the imaging signal processing circuit recited in claim 14.
